(19) United States
(12) Patent Application Publication
(10) Pub. No.: US 2008/0147205 A1
(43) Pub. Date: Jun. 19, 2008

(54) Method and System for Controlling Devices in a Network

(75) Inventors: Jeffrey D. Ollis, Dresher, PA (US); John Coogan, Lansdale, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/612,287

(22) Filed: Dec. 18, 2006

(51) Int. Cl. G05B 11/01

(52) U.S. Cl. 700/11

(57) ABSTRACT

A method and system for controlling one or more devices (104, 106, 108 and 110) in a network (100) is provided. The method includes accessing (304) weather-forecast data. Further, the method includes scheduling (306) operation of the one or more devices in the network as a function of the weather-forecast data.

### FIELD OF INVENTION

The present invention relates, in general, to networks and more specifically, to a method and system for controlling devices in a network.

### BACKGROUND OF THE INVENTION

Automation is the technique of making a device, a machine, a process or a procedure self-acting or self-controlled. Some applications of automation include industrial machinery and processes and various other devices. The advent of industrial automation was followed by the concept of home automation, which includes automating the devices in a house. Since its inception, home automation has been becoming increasingly popular due to the comfort and security it offers in the house. Some examples of automated household devices include lighting, air conditioning and heating systems, doors, windows, blinds, and water sprinklers.

In one of the techniques, home automation involves the use of remote controls to operate the devices in the house. However, this requires a user to manually operate the remote control. In another technique, a timer-based control of devices is implemented. Daily tasks such as switching on the light bulbs in the evening can be pre-programmed by using the timer. However, this system is not dynamic. As a result, if it gets dark early, the light bulbs would still switch on at a predefined time, resulting in the house being dark for a certain duration.

In yet another technique for home automation, data from various real-time sensors is used to operate the devices. This makes the system dynamic, for example, whenever a light sensor indicates that the ambient light has fallen below a minimum threshold value, the light bulbs automatically switch on. However, this system is efficient only in the case of devices such as lighting, the effect of which is instantaneous. For devices, the effect of which is gradual, for example, air-conditioners and heaters, this system is less efficient. Further, the system is also not efficient for devices that can be wasteful or detrimental when operated in excess, for example, a water sprinkler. In the case of the water sprinkler, when the moisture content of the soil falls below the minimum threshold value, the water sprinkler switches on automatically. However, if it rains as soon as the water sprinkler switches off, the sprinkled water is wasted. Hence, even though the system does not require any manual intervention for the operation of the devices, it is efficient only in limited cases and does not account for various situations, including the one mentioned above.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary network, where various embodiments of the present invention can be practiced;

FIG. 2 illustrates a block diagram of an exemplary automation system, in accordance with an embodiment of the present invention;

FIG. 3 is a flow diagram illustrating a method for controlling one or more devices in a network, in accordance with an embodiment of the present invention; and

FIG. 4 is a flow diagram illustrating a method for controlling one or more devices in a network, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for controlling devices in a network, in accordance with various embodiments of the present invention, it should be observed that the present invention resides primarily in combinations of method steps related to the method and system for controlling devices in a network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but can include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising.

In an embodiment, a method for controlling one or more devices in a network is provided. The method includes accessing weather-forecast data. Further, the method includes scheduling operation of the one or more devices in the network as a function of the weather-forecast data.

In another embodiment, an automation system is provided. The automation system includes a receiver, which is configured to receive weather-forecast data. Further, the automation system includes a controller, which is configured to schedule operation of one or more devices in a network, as a function of the weather-forecast data. The automation system also includes an interface, which is configured to transmit one or more control signals to operate the one or more devices. The one or more control signals correspond to the one or more devices.

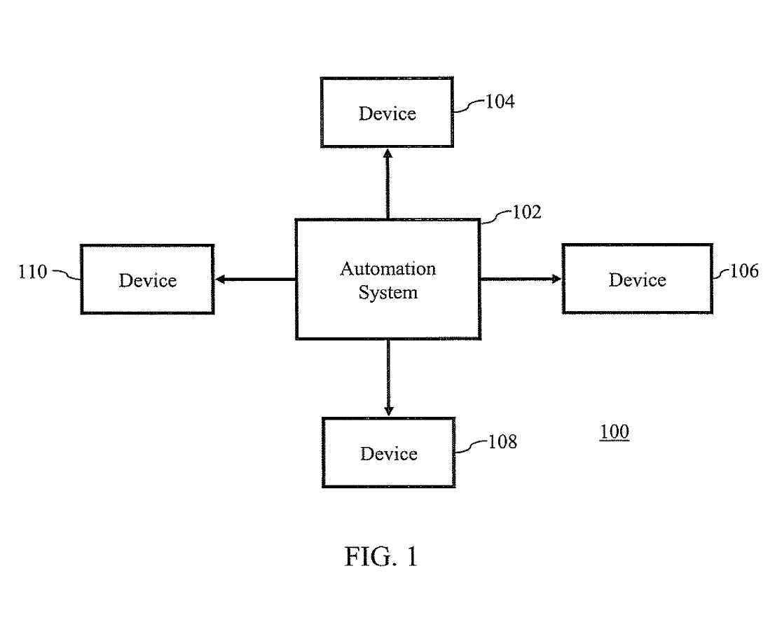

FIG. 1 illustrates an exemplary network 100, where various embodiments of the present invention can be practiced. Examples of the network 100 can include, but are not limited to, a Bluetooth network, an Infrared Data Association (IrDA) network, an X-10 network, a Z-Wave network, a ZigBee network, a Wireless Fidelity (WiFi) network, an Ethernet network, a UPB network, and a HomePlug network. The network 100 can include an automation system and one or more devices. For the purpose of this description, the network 100 is shown to include an automation system 102 and one or more devices 104, 106, 108, and 110. The one or more devices are connected to the automation system 102 in the network 100. The automation system 102 can control operation of the one or more devices in the network. Examples of the automation system include, but are not limited to, a home automation system, an office automation system, a computer, a laptop, a Personal Digital Assistant (PDA), and a mobile phone. Examples of the one or more devices include, but are not limited to, a water sprinkler, a motorized shutter, an air conditioner, a heater, a motorized blind, an antenna, a door, and a window. For an embodiment, the one or more devices can be similar, for example, all of the one or more devices can be storm shutters. For another embodiment, the one or more devices can be different, for example, the device 104 can be a water sprinkler, the device 106 can be a motorized blind, the device 108 can be an air conditioner, and the device 110 can be a door.

The one or more devices are connected to the automation system 102 via links. Examples of the links can include, but are not limited to, a Bluetooth link, an Infrared Data Association (IrDA) link, an X-10 link, a Z-Wave link, a ZigBee link, a Wireless Fidelity (WiFi) link, an Ethernet link, a UPB link, and a HomePlug link. The automation system 102 controls the one or more devices through the links. For an embodiment, the automation system 102 sends one or more control signals to the one or more devices. The one or more control signals correspond to the one or more devices. Further, the one or more devices operate, based on the one or more control signals.

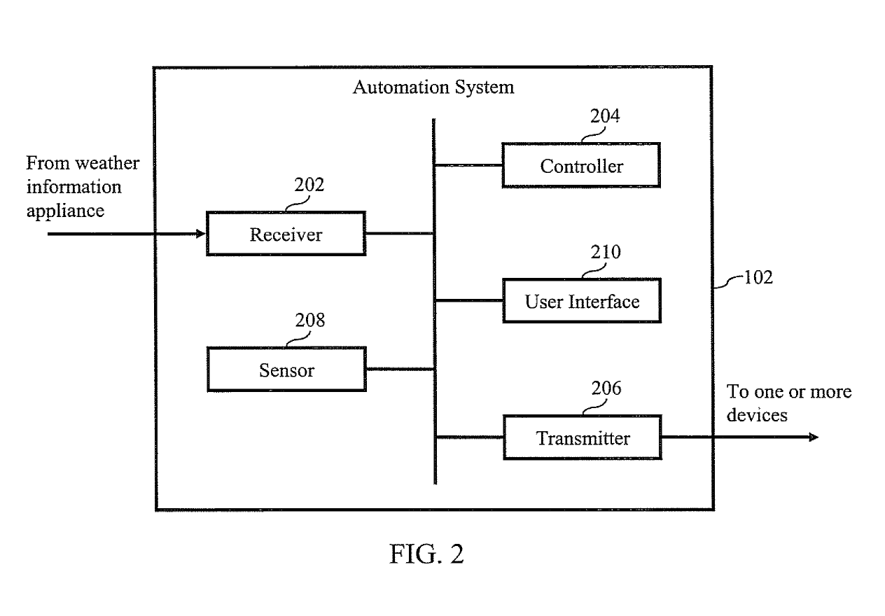

FIG. 2 illustrates a block diagram of an exemplary automation system 102, in accordance with an embodiment of the present invention. Those ordinarily skilled in the art will appreciate that the automation system 102 can include all or even a fewer number of components than the components shown in FIG. 2. Further, those ordinarily skilled in the art will understand that the automation system 102 can include additional components that are not shown here and are not germane to the operation of the automation system 102, in accordance with the inventive arrangements. To describe the automation system 102, reference will be made to FIG. 1, although it should be understood that the automation system 102 can be implemented in any other suitable environment or network.

The automation system 102 is used to control one or more devices in a network. The automation system 102 includes a receiver 202, a controller 204, and an interface 206. The receiver 202 is configured to receive weather-forecast data. Examples of the weather-forecast data can include, but are not limited to, precipitation forecast data, temperature forecast data, humidity forecast data, wind forecast data, severe weather-forecast data, and meteorological forecast data. For an embodiment, the receiver 202 receives the weather-forecast data from an information appliance. Examples of the information appliance can include, but are not limited to, a national weather information server, an online weather server, an online news server, a television station, and a weather radio station.

For an embodiment, the receiver 202 can receive the weather-forecast data via a wired or a wireless link. Examples of the wireless link include, but are not limited to, a Bluetooth link, an Infrared Data Association (IrDA) link, an X-10 link, a Z-Wave link, a ZigBee link, a Wireless Fidelity (WiFi) link, and an IEEE 802.11 link. Examples of the wired link include, but are not limited to, an Ethernet link, a UPB link, an X-10 link, and a HomePlug link. For another embodiment, the receiver 202 can receive the weather-forecast data from an intermediate device that obtains the weather-forecast data from the information appliance. For example, the intermediate device obtains the weather-forecast data from the information appliance and forwards it to the receiver 202. Examples of the intermediate device can include, but are not limited to, a computer, a laptop, a Personal Digital Assistant (PDA), a set-top box, and a mobile phone. Further, the receiver 202 forwards the weather-forecast data to the controller 204.

The controller 204 is configured to schedule operation of the one or more devices in the network, as a function of the weather-forecast data. An example of the controller 204 can be a processor. Further, the controller 204 can also generate one or more operation schedules corresponding to the one or more devices. The one or more operation schedules can be generated based on the weather-forecast data, actual weather data, or inputs received via the user interface 210. For an embodiment, the controller 204 is also configured to operate the one or more devices, based on the weather-forecast data. For this embodiment, the one or more devices can be operated, based on the one or more operation schedules. For an embodiment, the controller generates one or more control signals to operate the one or more devices. Further, the controller 204 forwards the one or more control signals to the interface 206, which transmits the one or more control signals to the corresponding one or more devices. The operation of the one or more devices is based on the one or more control signals. For example, a control signal can instruct the device to switch on as soon as the device receives the control signal. Examples of the control signal can include, but are not limited to, an instruction for switching on the device, an instruction for switching off the device, and an instruction for providing operation details to the device. Further, examples of the operation details can include, but are not limited to, the duration of the operation, the thermostat temperature and the fan speed.

For an embodiment, the automation system 102 can also include one or more sensors, to sense current weather data. For the purpose of this description, the automation system 102 is shown to include a sensor 208. Examples of the sensor 208 can include, but are not limited to, a temperature sensor, a humidity sensor, a precipitation sensor, and a wind-speed sensor. For an embodiment, the controller 204 is also configured to operate the one or more devices, based on the current weather data. The current weather data can be obtained from the sensor 208 or the information appliance. Examples of the information appliance can include, but are not limited to, a national weather information server, an online weather server, an online news server, a television station, and a weather radio station. For an embodiment, the sensor 208 can send the current weather data to the controller 204 via a wired or a wireless link. Examples of the wired link can include, but are not limited to, an X-10 link, an Ethernet link, a UPB link, and a HomePlug link. Examples of the wireless link can include, but are not limited to, a Bluetooth link, an Infrared Data Association (IrDA) link, an X-10 link, a Z-Wave link, a ZigBee link, and a Wireless Fidelity (WiFi) link.

For an embodiment, the controller 204 is also configured to operate the one or more devices based on actual weather data for a predefined time interval in the past. The actual weather data can be obtained from the sensor 208 or the information appliance. For an embodiment, the actual weather data pertaining to the predefined time interval is retrieved from a memory, which stores the actual weather data.

For an embodiment, the controller 204 can also operate the one or more devices, based on an input received from a user. For this embodiment, the automation system 102 includes a user interface 210, which facilitates the input of instructions for operating the one or more devices. Examples of the instructions can include, but are not limited to, instructions relating to the duration of the operation, the time of the operation, the thermostat temperature, and the fan speed. Further, the controller 204 can generate control signals, based on the instructions input via the user interface 210. The control signals can be transmitted to the one or more devices via the interface 206.

For an embodiment, once the controller 204 has generated the one or more operation schedules, based on the weather-forecast data or the actual weather data, the controller 204 can generate one or more control signals and forward them to the interface 206. The interface 206 is configured to transmit the one or more control signals, to operate the one or more devices. The interface 206 transmits the one or more control signals through a wired or a wireless link. Examples of the wired link can include, but are not limited to, an X-10 link, an Ethernet link, a UPB link, and a HomePlug link. Examples of the wireless link can include, but are not limited to, a Bluetooth link, an Infrared Data Association (IrDA) link, an X-10 link, a Z-Wave link, a ZigBee link, and a Wireless Fidelity (WiFi) link. The one or more devices receive the one or more control signals. Further, the one or more devices operate, based on the one or more control signals.

For an embodiment, the interface 206 can also perform additional intermediate functions that can include, but are not limited to, encoding the control signal and changing the format of the control signal. The format of the control signal may need to be changed to a format that can be read by the device. If the user interface 210 directly forwards the instructions to the interface 206, in an exemplary scenario, the interface 206 can change the format of the instructions to a format that is readable by the one or more devices. Further, the interface 206 can transmit the instructions for operating the one or more devices.

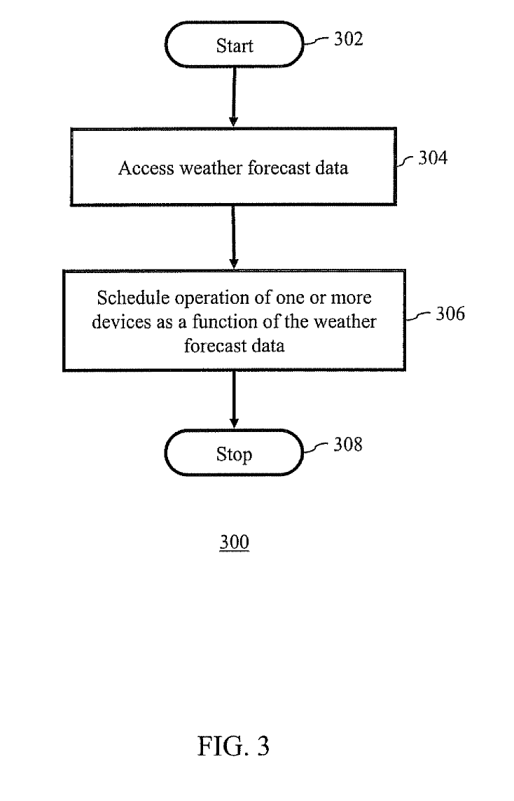

FIG. 3 is a flow diagram 300 illustrating a method for controlling one or more devices in a network, in accordance with various embodiments of the present invention. To describe the flow diagram 300, reference will be made to FIG. 1 and FIG. 2, although it should be understood that the flow diagram 300 can be implemented in any other suitable environment or network. Moreover, the invention is not limited to the order in which the steps are listed in the flow diagram 300.

The method for controlling one or more devices in a network begins at step 302. At step 304, weather-forecast data is accessed. The weather-forecast data is accessed by the receiver 202. Examples of the weather-forecast data can include, but are not limited to, precipitation forecast data, temperature forecast data, humidity forecast data, wind forecast data, severe weather-forecast data, and meteorological forecast data. For an embodiment, the weather-forecast data can be retrieved from an information appliance. Examples of the information appliance can include, but are not limited to, a national weather information server, an online weather server, an online news server, a television station, and a weather radio station.

At step 306, operation of the one or more devices is scheduled as a function of the weather-forecast data. For an embodiment, the controller 204 schedules the operation of the one or more devices. The controller 204 generates one or more operation schedules corresponding to the one or more devices. Thereafter, the method for controlling the one or more devices in the network ends at step 308.

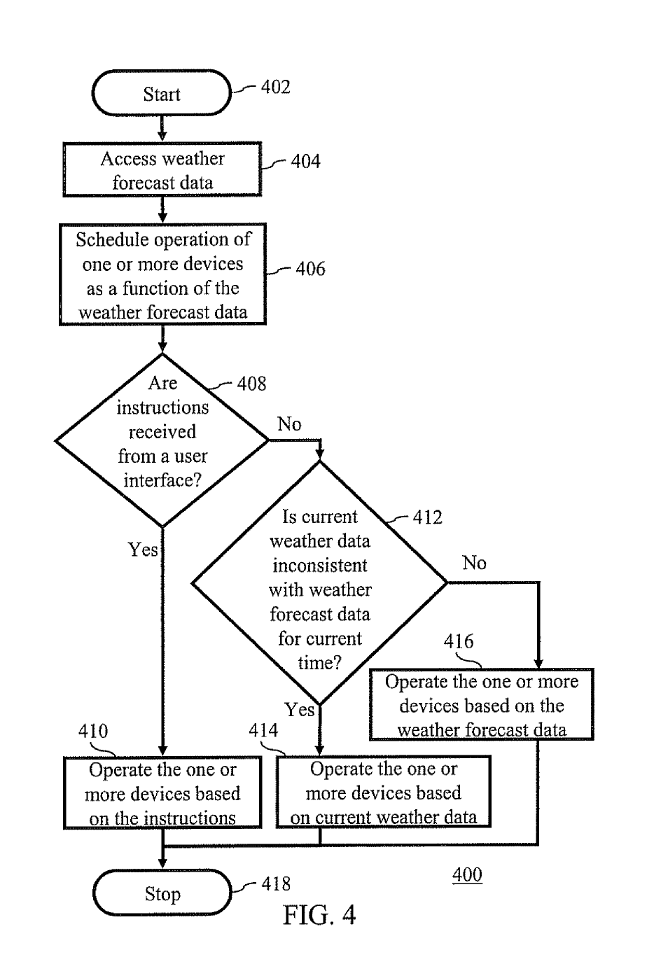

FIG. 4 is a flow diagram 400 illustrating a method for controlling one or more devices in a network, in accordance with another embodiment of the present invention. To describe the flow diagram 400, reference will be made to FIG. 1 and FIG. 2, although it should be understood that the flow diagram 400 can be implemented in any other suitable environment or network. Moreover, the invention is not limited to the order in which the steps are listed in the flow diagram 400.

The method for controlling one or more devices in a network begins at step 402. At step 404, weather-forecast data is accessed. The weather-forecast data is accessed by the receiver 202. Examples of the weather-forecast data can include, but are not limited to, precipitation forecast data, temperature forecast data, humidity forecast data, wind forecast data, severe weather-forecast data, and meteorological forecast data. For an embodiment, the weather-forecast data is retrieved from an information appliance. Examples of the information appliance can include, but are not limited to, a national weather information server, an online weather server, an online news server, a television station, and a weather radio station.

At step 406, operation of the one or more devices is scheduled as a function of the weather-forecast data. For an embodiment, the controller 204 schedules the operation of the one or more devices. The controller 204 generates one or more operation schedules corresponding to the one or more devices. For an embodiment, the operation of the one or more devices is scheduled, based on a predefined algorithm.

To understand the predefined algorithm, consider an exemplary scenario of the operation of a water sprinkler, which is scheduled to operate at a predefined time every day. If the amount of rain on a particular day is forecasted to be greater than a predefined value, the operation of the water sprinkler will be cancelled on that particular day, based on the predefined algorithm. In another example, the predefined algorithm can also cancel the operation of the water sprinkler on the day after the particular day, if the amount of rain is forecasted to be greater than another predefined value.

In another example of the predefined algorithm, consider the predefined algorithm for the operation of storm shutters in a vacation home. If a storm is predicted at a predefined time on a particular day, the controller 204 can schedule the storm shutters to completely seal the vacation home an hour in advance of the predefined time. This would be even more useful if the vacation home is unoccupied on the particular day and the operation of the storm shutters cannot be regulated manually.

Some examples of the predefined algorithm have been explained with reference to the water sprinkler and the storm shutter. However, it will be readily apparent to a person ordinarily skilled in the art that many different variations and extensions of the predefined algorithm can be applied to schedule the operation of the water sprinkler and the storm shutter, as well as various other devices. Further, the manner of operation of other devices can be different from that of the water sprinkler and the storm shutter.

For an embodiment, the predefined algorithm can be based on one or more predefined criteria. Examples of the one or more predefined criteria can include, but are not limited to, accuracy of the weather-forecast data, format of the weather-forecast data, and regional weather trends. For example, the predefined criterion can be the accuracy of the weather-forecast data with respect to the timing or intensity of the forecast. To understand the effect of the accuracy of the forecast, with respect to the timing on the predefined algorithm, consider the exemplary case of the operation of a water sprinkler. If rain is forecasted on a particular day, and the accuracy is below a threshold value, the predefined algorithm will get modified to cancel the operation of the water sprinkler on the particular day.

Further, the predefined algorithm can also modify the threshold values, based on the accuracy of the weather-forecast data. The threshold values can be modified by using a buffer value that is dependent on the accuracy. For example, consider that the threshold value of the wind speed, to operate the storm shutters, is 50 miles per hour (mph). However, if the accuracy of the weather-forecast data, with respect to the intensity, is 80 percent, the threshold value of the wind speed in the predefined algorithm is modified by subtracting a buffer that is equal to 10 mph. Hence, the new threshold value that can be used is 40 mph. This can act as an additional safety factor in the system.

In another example, the predefined criterion can be the format of the weather-forecast data. Examples of the format of the weather-forecast data, can include, but are not limited to, the percentage probabilities, the value of the intensity, the value of the amount, the daily prediction, the hourly prediction, and storm warnings. Based on the format of the weather-forecast data, conditions in the algorithm can be restructured accordingly.

For another example, the predefined criterion can be the regional weather trends. In a coastal region, where there is a high occurrence of sudden storms, the predefined algorithm can be modified to contain a separate condition relating to checking on storm updates at frequent intervals. In another example, in an equatorial region, where it rains very often, the threshold value in the predefined algorithm for the amount of rain needed to operate the water sprinkler can be reduced.

For an embodiment, the predefined algorithm can be altered manually, based on the above-mentioned predefined criteria. For another embodiment, the predefined algorithm can be automatically adapted, based on the one or more predefined criterions.

At step 408, it is determined whether instructions have been received from the user interface 210. The controller 204 determines whether the instructions have been received from the user interface 210. If it is determined at step 408 that the instructions have been received from the user interface 210, step 410 is performed. At step 410, the one or more devices are operated, based on the instructions received from the user interface 210. Examples of the instructions can include, but are not limited to, the intensity, the duration and the time of operation, the thermostat temperature and the fan speed. Further, the controller 204 can generate control signals, based on the instructions input via the user interface 210. Moreover, the control signals can be transmitted to the one or more devices via the interface 206. For an embodiment, the user interface 210 can forward the instructions directly to the interface 206.

If it is determined at step 408 that the instructions have not been received from the user interface 210, step 412 is performed. At step 412, it is determined whether the current weather data is inconsistent with the weather-forecast data for the current time. The controller 204 determines whether the current weather data is inconsistent with the weather-forecast data for the current time. Examples of the current weather data can include, but are not limited to, precipitation data, temperature data, humidity data, wind data, severe weather data, and meteorological data. The current weather data can be obtained from the sensor 208 or the information appliance. For an embodiment, the sensor 208 can be attached to the automation system 102. For another embodiment, the sensor 208 can be installed separately from the automation system 102 to facilitate the process of sensing the current weather data.

If it is determined at step 412 that the current weather data is inconsistent with the weather-forecast data, step 414 is performed. At step 414, the one or more devices are operated, based on the current weather data. For example, consider that a storm is forecasted at 1800 hours on an otherwise clear day. In this example, if the storm begins at 1200 hours, it is determined that the weather-forecast for 1200 hours is inconsistent with the current weather for 1200 hours. In this example, instead of operating the storm shutters, based on the weather-forecast data (clear weather), the controller 204 operates the storm shutters, based on the signals received from a wind speed sensor, which senses that the wind speed has crossed a threshold value.

If it is determined at step 412 that the current weather data is not inconsistent with the weather-forecast data, step 416 is performed. At step 416, the one or more devices are operated by the controller 204, based on the weather-forecast data. The controller 204 operates the one or more devices, based on the one or more schedules generated at step 406. The controller 204 generates one or more control signals, based on the one or more operation schedules. Further, the controller 204 forwards the one or more control signals to the interface 206, which transmits the one or more control signals to the one or more devices. Examples of a control signal can include, but are not limited to, an instruction to switch on the device, an instruction to switch off the device, and an instruction to provide operation details to the device. Examples of the operation details can include, but are not limited to, the intensity and duration of the operation, the thermostat temperature, and the fan speed. Thereafter, the method for controlling one or more devices in a network ends at step 418.

For another embodiment, the one or more devices can be operated, based on actual weather data for a predefined time interval in past. The actual weather data can be obtained from the information appliance. Examples of the information appliance can include, but are not limited to, a national weather information server, an online weather server, an online news server, a television station, and a weather radio station. For an embodiment, the actual weather data can be obtained from a memory that stores the current weather data measured by the one or more sensors. The actual weather data for the predefined time interval in the past is compared with the weather-forecast data for the predefined time interval. If the actual weather data is inconsistent with the weather-forecast data for the predefined time interval, the one or more devices are operated, based on the actual weather data.

For example, if heavy rain is forecasted for a particular day, and, based on the predefined algorithm, the operation of the water sprinkler is cancelled for the particular day as well as the day after. In this example, consider that there is no rain on the particular day. Consequently, on the next day, the controller 204 finds that the actual weather data for the particular day was inconsistent with the weather-forecast data for the particular day. Thereafter, the controller 204 reschedules the water sprinkler to be switched on the next day, so that the lawn does not remain dry.

Various embodiments of the present invention, as described above, offer several advantages, some of which are discussed here. Firstly, the present invention provides a method for automatically scheduling the operation of devices in a network, based on weather-forecast data. Secondly, the present invention allows an override of the schedule, based on the actual weather data and/or inputs from a user. This has the advantage of making the automation process more robust and efficient. Thirdly, the present invention prevents wastage of resources in the case of certain devices, for example, a water sprinkler, and thereby reduces the net cost of operating these devices.

It will be appreciated that the method and system for controlling one or more devices in a network, described herein, may comprise one or more conventional processors and unique stored program instructions that control the one or more processors, to implement, in conjunction with certain non-processor circuits, some, most, or all of the functions of the system described herein. The non-processor circuits can include, but are not limited to, signal drivers, clock circuits, power-source circuits and user-input devices. As such, these functions may be interpreted as steps of a method to enable control of the one or more devices. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of those claims, as issued.

What is claimed is:

1. A method for controlling one or more devices in a network, the method comprising:
accessing weather-forecast data; and
scheduling operation of the one or more devices in the network as a function of the weather-forecast data.

2. The method as recited in claim 1 further comprising transmitting one or more control signals to operate the one or more devices.

3. The method as recited in claim 1, wherein the scheduling is based on a predefined algorithm.

4. The method as recited in claim 3, wherein the predefined algorithm is based upon one or more of the following criteria: accuracy of the weather-forecast data, format of the weather-forecast data, and regional weather trends.

5. The method as recited in claim 1 further comprising operating the one or more devices based on instructions received via a user interface.

6. The method as recited in claim 1, wherein the weather-forecast data is selected from the group comprising precipitation forecast data, temperature forecast data, humidity forecast data, wind forecast data, severe weather-forecast data, and meteorological forecast data.

7. The method as recited in claim 1 wherein the accessed weather-forecast data is retrieved from an information appliance.

8. The method as recited in claim 7, wherein the information appliance is selected from the group comprising a national weather information server, an online weather server, an online news server, a television station, and a weather radio station.

9. The method as recited in claim 1 further comprising operating the one or more devices based on a current weather data when the weather-forecast data for a current time is inconsistent with the current weather data.

10. The method as recited in claim 9, wherein the current weather data is obtained from at least one of one or more sensors and the information appliance.

11. An automation system comprising:
a receiver configured to receive weather-forecast data;
a controller configured to schedule operation of one or more devices in a network as a function of the weather-forecast data; and
an interface configured to transmit one or more control signals to operate the one or more devices, wherein the one or more control signals correspond to the one or more devices.

12. The automation system as recited in claim 11, wherein the weather-forecast data is received from an information appliance.

13. The automation system as recited in claim 11, wherein the controller is further configured to operate the one or more devices based on the weather-forecast data.

14. The automation system as recited in claim 11, wherein the controller is further configured to operate the one or more devices based on a current weather data.

15. The automation system as recited in claim 11 further comprising one or more sensors configured to sense a current weather data.

16. The automation system as recited in claim 11, wherein the controller is further configured to operate the one or more devices based on actual weather data for a predefined time interval in past.

17. The automation system as recited in claim 11 further comprising a user interface to facilitate input of instructions for operating the one or more devices.

18. The automation system as recited in claim 11, wherein the interface is further configured to transmit the one or more control signals through at least one of a wired link and a wireless link.

19. The automation system as recited in claim 18, wherein the wireless link is selected from the group comprising a Bluetooth link, an Infrared Data Association (IrDA) link, an X-10 link, a Z-Wave link, a ZigBee link, and a Wireless Fidelity (WiFi) link.

20. The automation system as recited in claim 18, wherein the wired link is selected from the group comprising an X-10 link, an Ethernet link, a UPB link, and a HomePlug link.
